(19) United States
(12) Patent Application Publication
(10) Pub. No.: US 2026/0006545 A1
(43) Pub. Date: Jan. 1, 2026

(54) MANAGEMENT OF SLEEPING CELL STATES

(71) Applicant: T-MOBILE INNOVATIONS LLC, Overland Park, KS (US)

(72) Inventors: Raymond Emilio REEVES, Orlando, FL (US); Simon Youngs, Overland Park, KS (US)

(21) Appl. No.: 18/758,313

(22) Filed: Jun. 28, 2024

(51) Int. Cl. H04W 52/02; H04W 24/02; H04W 24/08

(52) U.S. Cl. CPC H04W 52/0206; H04W 24/02; H04W 24/08

(57) ABSTRACT

Systems and methods are provided for proactive sleeping cell detection and mitigation. Aspects herein proactively detect when network cells are degrading based on cell performance metrics comprising cell signal, cell utilization, etc. When cells are identified as degrading but not yet classified as a sleeping cell, proactive traffic re-allocation can be initiated such that traffic of the degrading cell is transferred to a different cell. Once the traffic is re-allocated (i.e., all traffic of the degrading cell has been moved off of the degrading cell), corrective action(s) can be initiated to prevent the cell from continued degradation and future classification as a sleeping cell. Upon completion of the corrective action(s), the traffic can be moved back to what was the initial cell that was previously degrading.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for proactive identification of potential sleeping cells. More particularly, in aspects set forth herein, systems and methods enable identification of cells with degrading performance metrics such that cells approaching a sleeping cell status are proactively identified and corrective action can be automatically initiated.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a flow diagram of a method for sleeping cell mitigation, in accordance with aspects herein;

FIG. 3 depicts a flow diagram of a method for sleeping cell mitigation, in accordance with aspects herein; and

FIG. 4 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, 6G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, antenna array configuration corresponding to both the access point and the UE, among other factors. The base stations are employed to broadcast and transmit transmissions to user devices of the telecommunications network.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

The present disclosure is directed to proactive management of sleeping cells. As telecommunication networks embark to automate aspects of network operations, a persistent issue is cells that are powered on yet not offering service as expected, while no alert is provided to the network that there is a problem. Such cells are referred to herein as “sleeping cells” as they are live but useless and not identified as non-functioning. In order to detect and reset sleeping cells, network providers have proposed tracking periodic accounting metrics so that tonnage served is used as the determining factor to flag a cell as sleeping and take action on said cell. However, these accounting metrics are generated in fractions of hours and, at best, quarter hour intervals, which is not fast enough.

To address these issues, systems and methods are proposed herein for real-time sleeping cell auto-location enhancement architectures that leverage existing real-time signaling trace infrastructure and, thus, create a cell service profile that is updated continuously to determine any deviation reflecting potential degradation or cessation of an activity (e.g., decreased user population, lower signaling, decreased tonnage, increased jitter, etc.). Such an architecture would allow for a reliable determination of service cessation and trigger automatic service restoration events (e.g., software restart, hard equipment restart, etc.). This architecture provides a proactive approach rather than a delayed reactive approach that monitors periodic accounting metrics on a delayed timeline.

A focus of aspects herein seeks to predict a sleeping cell or service degradation before it reaches a sleeping cell status. In order to do this, aspects provide for probing of a network to access predetermined cell metrics comprising cell signal history, cell utilization, uplink/downlink traffic patterns, a number of users, and the like. Cell signal history for a cell comprises any signal event such as a reset, a UE-triggered service request, unsuccessful handoffs, etc. Cell utilization can be measured by an increase or decrease in tonnage. Uplink/downlink patterns may be routine-based for users. For instance, a network may identify that a first UE is generally active on the network at X time at cell Y and A time at cell B but note that at X time the first UE didn't attach at the expected site.

Any one of the above predetermined cell metrics, or a combination thereof, can be relied on to generate a predictive value indicating whether the cell is in a sleeping cell state. The predictive value may be a configurable numerical value that is preset by a user. The predictive value, in aspects, is a percentage value. The predictive value can be compared to a predetermined sleeping cell state threshold (also referred to herein as a sleeping cell threshold), which can be configurable by a user. The predetermined sleeping cell state threshold can have variable ranges indicating a variety of states. For instance, a predetermined sleeping cell state threshold can indicate when a cell is in a sleeping state, approaching a sleeping state, not performing as expected, or performing as expected. Thus, a network does not need to wait for a cell to enter a sleeping state in order to act. Rather, an indication that the cell is approaching a sleeping state is sufficient to take restorative action such as an automatic restoration event. An automatic restoration event, as used herein, refers generally to an action initiated by the network to reinstate a sleeping cell to an active service state.

Accordingly, a first aspect of the present disclosure is directed to a system for managing sleeping cells. The system comprises one or more processors and one or more computer-readable media storing computer-usable instructions that, when executed by the one or more processors, cause the one or more processors to: receive cell performance metrics for a plurality of cells on a network, wherein cell performance metrics are measured using an optimal performance threshold, a sleeping cell threshold, and a predetermined potential degradation threshold; identify a first cell having one or more cell performance metrics that trigger the predetermined potential degradation threshold, wherein the one or more cell performance metrics do not trigger the sleeping cell threshold; re-allocate traffic from the first cell to one or more other cells; and initiate service corrective action for the first cell.

A second aspect of the present disclosure is directed to a method for managing sleeping cells. The method comprises receiving cell performance metrics for a plurality of cells on a network, wherein cell performance metrics are measured using an optimal performance threshold, a sleeping cell threshold, and a predetermined potential degradation threshold; identifying a first cell having one or more cell performance metrics that trigger the predetermined potential degradation threshold, wherein the one or more cell performance metrics do not trigger the sleeping cell threshold or the optimal performance threshold; re-allocating traffic from the first cell to one or more other cells; and initiating service corrective action for the first cell.

Another aspect of the present disclosure is directed to a system for managing sleeping cells. The system comprises one or more processors and one or more computer-readable media storing computer-usable instructions that, when executed by the one or more processors, cause the one or more processors to: receive cell performance metrics for a plurality of cells; evaluate cell performance metrics with respect to an optimal performance threshold and a sleeping cell threshold for each of the plurality of cells; predict a first cell is degrading when a first cell performance threshold is below the optimal performance threshold and above the sleeping cell threshold for a predetermined period of time; re-allocate a first set of traffic from the first cell to one or more other cells; and automatically initiate a service corrective action for the first cell.

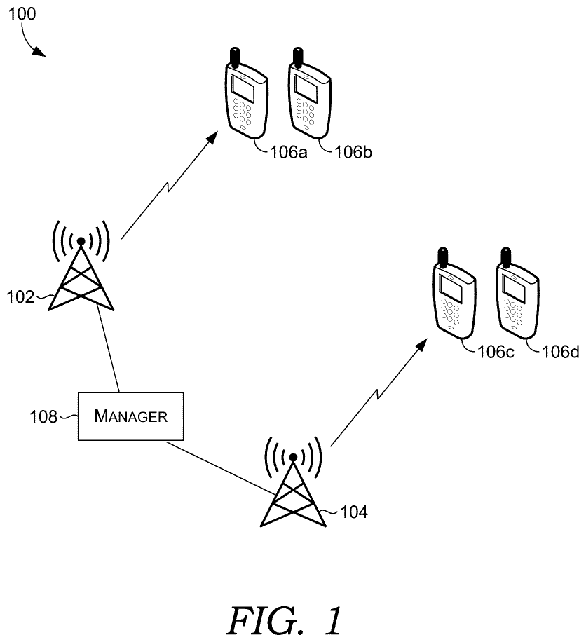

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

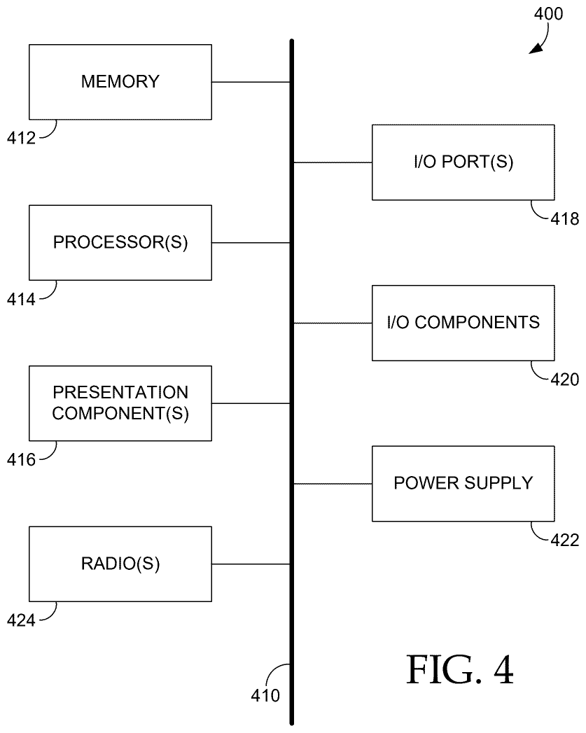

A network cell may comprise a base station 102 or 104 to facilitate wireless communication between a communications device within the network cell, such as communications device 400 described with respect to FIG. 4, and a network. As shown in FIG. 1, communications device may be UE 106a, 106b, 106c, or 106d (referring to collectively herein as UE 106a-d). In the network environment 100, UE 106a-d may communicate with other devices, such as mobile devices, servers, etc. The UE 106a-d may take on a variety of forms, such as a personal computer, a laptop computer, a tablet, a netbook, a mobile phone, a Smart phone, a personal digital assistant, or any other device capable of communicating with other devices. For example, the UE 106a-d may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102a-d comprises a wireless or mobile device with which a wireless telecommunication network(s) can be utilized for communication (e.g., voice and/or data communication). In this regard, the UE 102a-d can be any mobile computing device that communicates by way of, for example, a 5G network.

The UE 102a-d may utilize a network to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network is associated with a telecommunications provider that provides services to user devices, such as UE 102a-d. For example, the network may provide voice services to user devices or corresponding users that are registered or subscribed to utilize the services provided by a telecommunications provider.

As shown in FIG. 1, one or more UEs, such as UE 106a-d, may be connected to a base station, such as base stations 102 and 104. In FIG. 1, UEs 106a and 106b are connected to base station 102 while UEs 106c and 106d are connected to base station 104. A manager 108 is illustrated in communication with each of base station 102 and base station 104. The manager 108 may be a disparate component located separately from a base station or may be an integral component of a base station. Whether disparate or integrated, the manager 108 can be in communication with one or more base stations at a time. The manager 108, as depicted herein, monitors network performance via one or more performance metrics in order to mitigate sleeping cell interference with network performance. Sleeping cells, as referenced herein, refer generally to a cell (i.e., base station) that is live/online but is not functioning. Exemplary performance metrics utilized herein, as previously mentioned, can include cell signal history, cell utilization, traffic patterns, user capacity, and the like. Any one of the performance metrics, or a combination thereof, can be relied on to generate a predictive value indicating a potential degradation of a cell.

A potential degradation of a cell is a proactive identification of a cell that is underperforming. This can be identified using one or more performance thresholds. For instance, an optimal performance threshold is a predetermined threshold that indicates a cell is performing as expected and is in an optimal range for performance. A sleeping cell state threshold is a predetermined threshold that indicates a cell is in a sleeping state and, thus, not performing/functioning. A predetermined potential degradation threshold is a predetermined threshold that indicates a cell is not satisfying the optimal performance threshold or the sleeping cell state threshold. For example, if the thresholds are referenced in terms of percentages, an optimal performance threshold may register at a performance value of 80% or higher while a sleeping cell state threshold may be triggered at a performance value of 30% or lower. In that example, a predetermined potential degradation threshold may be any value that is less than 80% but higher than 30%. These values are merely exemplary and can be configured by a user.

The threshold values may be monitored over time as well such that a value that is satisfying the optimal performance threshold but declining over time may immediately trigger a potential degradation threshold as a pattern of decline is present. As shown by way of examples, the present disclosure seeks to proactively identify degradation or sleeping cell states by identifying when cells are approaching a sleeping cell state, rather than when the cells are actively classified as a sleeping cell.

The above example conveyed a prediction based on performance values but the predictive analytics used herein can rely on any of the performance metrics discussed herein. For instance, cell signal data may be monitored over time such that a decrease in cell signal at a particular time triggers a potential degradation. Alternatively, cell utilization may indicate that a cell utilization value has decreased from X utilization to Y utilization in a period of time that indicates a potential degradation. Any one, or a combination, of the cell performance metrics can be relied on to indicate a potential degradation and approach of a sleeping cell state.

The monitoring and predictions can be manager by manger 108. As the manager 108 identifies potential degradations leading to sleeping cell states, the manager 108 can proactively, and without user intervention, re-allocate traffic from a cell experiencing degradation to another cell. For instance, assume that cell 102 is experiencing one or more cell performance metrics that indicate it is degrading (e.g., a decrease in cell utilization, cell signal decreasing, increases in handovers, etc.). The manger 108, upon identifying such degradation, can send instructions for the UEs 106a and 106b to transfer from the cell 102 to cell 104. Once the traffic is cleared from the degrading cell (cell 102 in the present example), the manager 108 can initiate a service corrective action for the degrading cell. A service corrective action, as used herein, refers generally to a reset of the cell in the form of a hardware reset or a software reset. For example, a service corrective action can comprise a hardware reset of the cell such that it is powered off and back on, configuration changes to the cell, and the like. This self-healing aspect provides immediate restoration of service since the corrective action is automatically initiated. Once the corrective action is complete, the previously re-allocated traffic can be moved back to the original cell. Or, continuing on with the previous example, the traffic (e.g., UEs 106a and 106b)can be returned from cell 104 back to cell 102 upon completion of the corrective action.

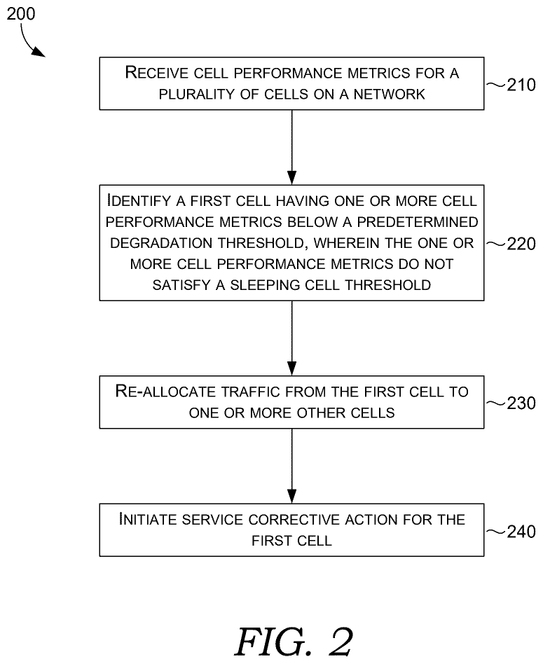

Turning to FIG. 2, a flow diagram 200 is provided illustrating a flow to manage or mitigate sleeping cell disruptions to a network. The method begins at block 210 with receiving cell performance metrics for a plurality of cells on a network. The cell performance metrics are measured using an optimal performance threshold, a sleeping cell threshold, and a predetermined potential degradation threshold. At block 220, a first cell having one or more cell performance metrics that trigger the predetermined potential degradation threshold is identified. The one or more cell performance metrics do not trigger the sleeping cell threshold but are determined to have not satisfied the optimal performance threshold. At block 230, traffic is re-allocated from the first cell to one or more other cells. Upon transferring the traffic, a service corrective action is initiated for the first cell at block 240.

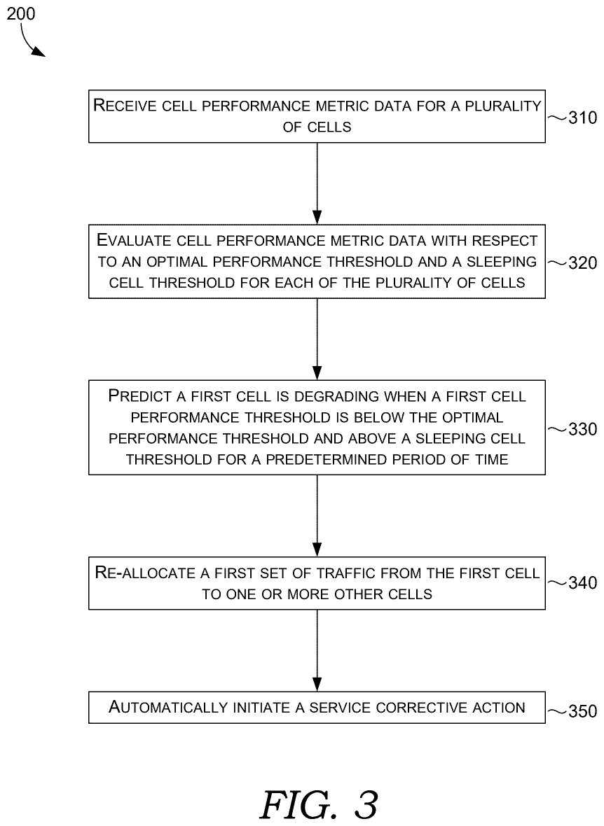

Referring to FIG. 3, a flow diagram 300 is provided illustrating a flow to manage or mitigate sleeping cell disruptions to a network. At block 310, cell performance metrics for a plurality of cells is received. At block 320, cell performance metrics are evaluated with respect to an optimal performance threshold and a sleeping cell threshold for each of the plurality of cells. It is predicted that a first cell is degrading when a first cell performance threshold is below the optimal performance threshold and above the sleeping cell threshold for a predetermined period of time at block 330. At block 340, a first set of traffic is re-allocated from the first cell to one or more other cells. At block 350, a service corrective action is automatically initiated for the first cell.

Referring to FIG. 4, a block diagram of an exemplary computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. It should be noted that although some components in FIG. 4 are shown in the singular, they may be plural. For example, the computing device 400 might include multiple processors or multiple radios. In aspects, the computing device 400 may be a UE/WCD, or other user device, capable of two-way wireless communications with an access point. Some non-limiting examples of the computing device 400 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 6 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 616 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for managing sleeping cells, the system comprising:
one or more processors; and
one or more computer-readable media storing computer-usable instructions that, when executed by the one or more processors, cause the one or more processors to:
receive cell performance metrics for a plurality of cells on a network, wherein cell performance metrics are measured using an optimal performance threshold, a sleeping cell threshold, and a predetermined potential degradation threshold;
identify a first cell having one or more cell performance metrics that trigger the predetermined potential degradation threshold, wherein the one or more cell performance metrics do not trigger the sleeping cell threshold;
re-allocate traffic from the first cell to one or more other cells; and
initiate service corrective action for the first cell.

2. The system of claim 1, wherein the one or more processors is further configured to transfer the traffic from the one or more other cells back to the first cell after completion of the service corrective action.

3. The system of claim 1, wherein the cell performance metrics comprises one or more of cell signal data and cell utilization data.

4. The system of claim 3, wherein the cell signal data comprises handoff data.

5. The system of claim 3, wherein the cell signal data comprises a decrease in a number of user equipment-initiated service requests.

6. The system of claim 1, wherein the cell performance metrics comprise traffic patterns.

7. The system of claim 1, wherein the service corrective action is a hardware reset of the first cell.

8. The system of claim 1, wherein the service corrective action comprises configuration changes to the first cell.

9. A method for managing sleeping cells, the method comprising:
receiving cell performance metrics for a plurality of cells on a network, wherein cell performance metrics are measured using an optimal performance threshold, a sleeping cell threshold, and a predetermined potential degradation threshold;
identifying a first cell having one or more cell performance metrics that trigger the predetermined potential degradation threshold, wherein the one or more cell performance metrics do not trigger the sleeping cell threshold or the optimal performance threshold;
re-allocating traffic from the first cell to one or more other cells; and
initiating service corrective action for the first cell.

10. The method of claim 9, further comprising transferring the traffic from the one or more other cells back to the first cell after completion of the service corrective action.

11. The method of claim 9, wherein the cell performance metrics comprises one or more of cell signal data and cell utilization data.

12. The method of claim 11, wherein the cell signal data comprises handoff data.

13. The method of claim 11, wherein the cell signal data comprises a decrease in a number of user equipment-initiated service requests.

14. The method of claim 9, wherein the service corrective action is a hardware reset of the first cell.

15. The method of claim 9, wherein the service corrective action comprises configuration changes to the first cell.

16. A system for managing sleeping cells, the method comprising:
one or more processors; and
one or more computer-readable media storing computer-usable instructions that, when executed by the one or more processors, cause the one or more processors to:
receive cell performance metrics for a plurality of cells;
evaluate cell performance metrics with respect to an optimal performance threshold and a sleeping cell threshold for each of the plurality of cells;
predict a first cell is degrading when a first cell performance threshold is below the optimal performance threshold and above the sleeping cell threshold for a predetermined period of time;
re-allocate a first set of traffic from the first cell to one or more other cells; and
automatically initiate a service corrective action for the first cell.

17. The method of claim 16, wherein the service corrective action is a hardware reset of the first cell.

18. The method of claim 16, wherein the service corrective action comprises configuration changes to the first cell.

19. The method of claim 16, wherein the one or more processors is further configured to transfer the first set of traffic from the one or more other cells back to the first cell after completion of the service corrective action.

20. The method of claim 16, wherein the cell performance metrics comprises one or more of cell signal data and cell utilization data.
